(19) United States
(12) Patent Application Publication
(10) Pub. No.: US 2007/0269040 A1
(43) Pub. Date: Nov. 22, 2007

(54) Cryptographic Protocol for Commonly Controlled Devices

(75) Inventors: Gideon A. Yuval, Mercer Island, WA (US); Peter E.H. Hauser, Kirkland, WA (US); Yacov Yacobi, Mercer Island, WA (US); Daniel R. Simon, Kirkland, WA (US); Joby S. Lafky, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/383,725

(22) Filed: May 16, 2006

(51) Int. Cl. H04L 9/30

(52) U.S. Cl. 380/30

(57) ABSTRACT

This document describes tools that enable secure communication between devices that are within a user's common control. These commonly controlled devices may follow a protocol, for example, where each commits to its own public key and receives a commitment of the other's public key, publishes its own public key and receives the other's public key, and authenticates the other's public key based on the received commitment of the other's public key. If authentic, each device computes an identifier based on the other's public key and its own private key associated with its own public key. A user may interact with the devices to confirm that the identifiers are the same. If they are the same, the devices may communicate securely.

### BACKGROUND

If a user wants two commonly controlled devices to communicate securely, he or she may purchase them as a set-in which case the manufacturer may have set up secure communication between them before purchase. In many cases, however, users have devices without secure communication already setup, such as a laptop and PDA purchased separately or from different manufacturers.

Some current solutions use a process to set up secure communication with the user's help and a large number. For example, the user's laptop could display “1509385761” to the user and the user could type that number into his or her PDA. If his or her PDA has the same number stored in memory, the setup process for secure communication is confirmed by the PDA. But users often struggle with large numbers. In this example the user needs to type “1509385761” into his or her PDA. This can be irritating to the user even if he or she types it in correctly, which he or she often will not. And, aside from user error or irritation, these solutions are often only as secure as the size of number used. If some other device interlopes between the user's laptop and PDA, for instance, this other device can break the security of the user's communication if it or its owner can figure out the large number.

### SUMMARY

This document describes tools that enable secure communication between devices that are commonly controlled by a user. These tools do not require that the devices have or pass any shared secret information and are effective to prevent active interlopers from successfully attacking their communications to a very high probability. Also, the tools may interact with a user that has control of the devices without requiring that the user compare large numbers or text.

Consider, for example, two commonly controlled devices that need to communicate wirelessly and securely. These wireless devices may follow a protocol where each commits to its own public key and receives a commitment of the other's public key, publishes its own public key and receives the other's public key, and authenticates the other's public key based on the received commitment of the other's public key. If authentic, each wireless device computes an identifier based on the other's public key and its own private key associated with its own public key. A user may interact with the wireless devices to confirm that the identifiers are the same. If they are the same, the wireless devices may communicate securely.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 is an exemplary process illustrating one way in which two wireless devices illustrated in FIG. 1 may act to enable secure communication according to a particular embodiment of a cryptographic protocol.

FIG. 3 is an exemplary process illustrating various embodiments and manners in which the tools may enable secure communication between commonly controlled devices.

The same numbers are used throughout the disclosure and figures to reference like components and features.

### DETAILED DESCRIPTION

### Overview

The following document describes tools capable of enabling secure communication between commonly controlled devices. These tools may do so using a cryptographic protocol where each of the devices generate fresh public/private key pairs, publish a cryptographic hash of their public keys before publishing those public keys, publish and receive each other's public keys once they have received the other device's hash, and authenticate the other device's public key using the received hash. Once authenticated, each of the devices may present an identifier to a user based on a session key of its private key and the other device's public key. The user may indicate that both identifiers are the same; if he or she does so, then the devices may communicate with a very high probability that the communication is secure.

An environment in which the tools may enable these and other actions is set forth below in a section entitled Exemplary Operating Environment. This section is followed by another section describing an exemplary way in which two particular wireless devices may act to enable secure communication and is entitled Example Using Devices A and B. A final section describes various other embodiments and manners in which the tools may enable secure communication between commonly controlled devices, whether wireless or otherwise, and is entitled Other Embodiments of the Tools. This overview, including these section titles and summaries, is provided for the reader's convenience and is not intended to limit the scope of the claims or the entitled sections.

### Exemplary Operating Environment

Before describing the tools in detail, the following discussion of an exemplary operating environment is provided to assist the reader in understanding ways in which various inventive aspects of the tools may be employed. The environment described below constitutes but one example and is not intended to limit application of the tools to any one particular operating environment or device type. Other environments and device types may be used without departing from the spirit and scope of the claimed subject matter.

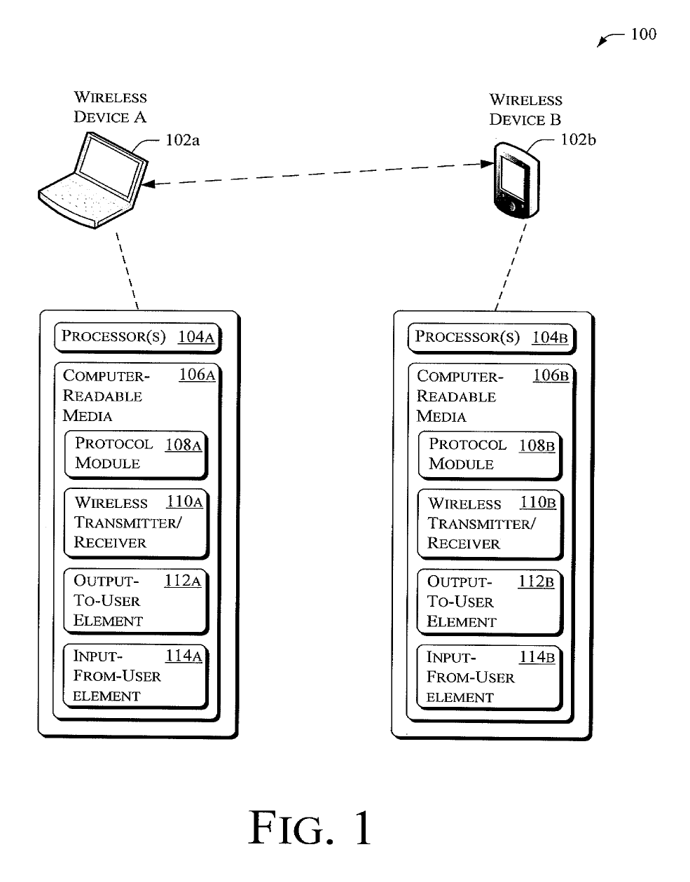

FIG. 1 illustrates one such operating environment generally at 100 comprising two commonly controlled computing devices A and B, designated at 102a and 102b. These devices are commonly controlled in the sense that a user can interact with both of them out-of-band, that is, outside of the form of communication in which the devices communicate with each other. This out-of-band communication can be physical, such as that which is enabled by a user having common physical control of the devices. With common physical control a user may, for example, view a display on each device and respond physically by pressing a button on each device. Or a user may have physical control of one device and control of the other device through another user trusted by the first user. In this way, the first user may control the first device and effectively control the second device by communicating with the other user (e.g., about whether both devices are displaying the same text and telling the other user to physically confirm this on the other device). The communication between the users should be secure against an active interloper, such as when the first and other user are talking to each other and know each other's voice.

Each of the devices comprises one or more processor(s) 104a or 104b and computer-readable media 106a or 106b, respectively. Wireless device A is illustrated as a laptop and wireless device B as a personal digital assistant (PDA), though other types of devices such as a smart phone, desktop, or tablet PC (to name just a few) may also be used. The tools may be used with devices that communicate non-wirelessly as well, such as devices that communicate through wires to a communication network (not shown).

Each device's processors are capable of accessing and/or executing computer-readable instructions on their computer-readable media. Each computer-readable media comprises or has access to a protocol module 108a or 108b. At least one of the protocol modules is capable of providing public/private key pairs, computing cryptographic hashes, and computing a session key based on its own private key and a received public key, as will be described in greater detail below.

Each device (and its media) may also comprise a wireless transmitter/receiver 110a or 110b, an output-to-user element 112a or 112b, and an input-from-user element 114a or 114b. Each of the transmitter/receiver and elements 112 and 114 may be integral with each other or the protocol module in any combination. Each may also comprise hardware and software. The transmitter/receiver, for instance, may comprise a physical device to send and receive wireless communications and software resident on the computer-readable media and used to manage the physical device; this software may operate integrated with or separate from the protocol module.

Each output-to-user element is capable of indicating text to a user, such as a four-digit number through a visual display. In some cases one of the devices may not have an output-to-user element, such as in cases where only one of the devices displays a number and the other receives the number from the user but does not display it. Each input-from-user element is capable of receiving input from a user, such as text input through a keyboard or a selection through a button.

### Example Using Devices A and B

In this section the two wireless devices A and B of FIG. 1 are used to describe one exemplary way in which the tools may interact to enable secure communication between commonly controlled devices. This example is an implementation of the tools but is not intended to limit the scope of the tools or the claimed embodiments.

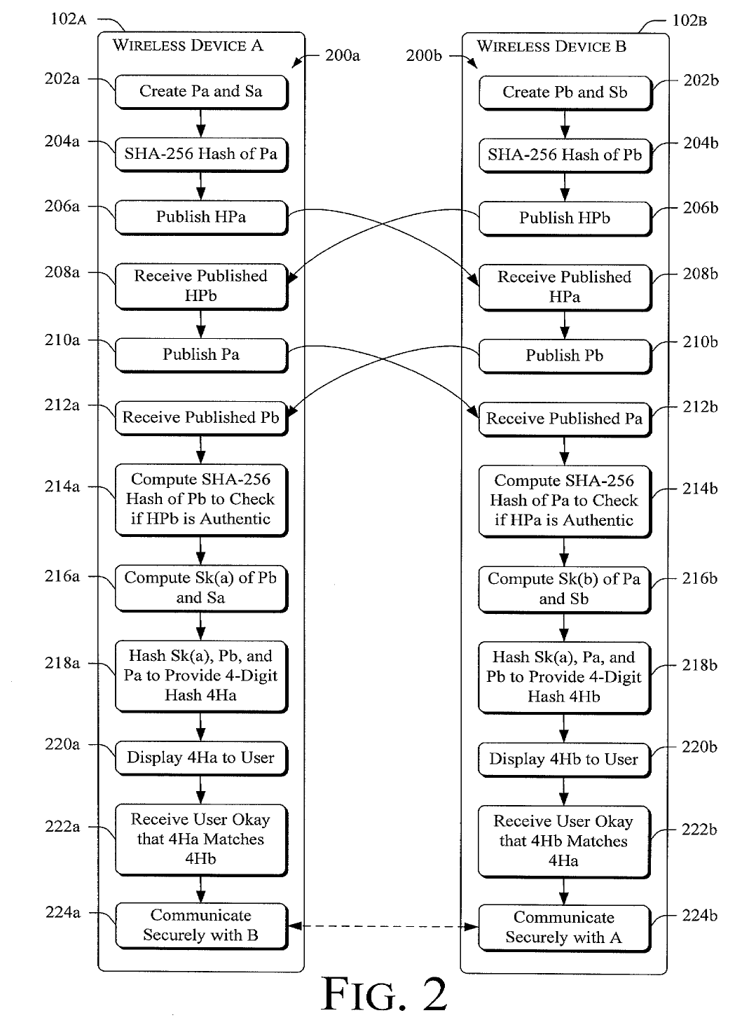

This example is illustrated with two parallel processes 200a and 200b of FIG. 2. These processes show actions of and between wireless devices A and B and are illustrated as a series of blocks representing individual operations or acts performed by the wireless devices of FIG. 1, including acts specific to parts of the devices (e.g., protocol modules 108a and 108b). These and other processes described herein may be implemented in any suitable hardware, software, firmware, or combination thereof; in the case of software and firmware, these processes represent sets of operations implemented as computer-executable instructions stored in computer-readable media and executable by one or more processors.

At blocks 202a and 202b each device's protocol module 108a or 108b creates fresh public/private key pairs: Pa and Sa by device A and Ph and Sb by device B. In this embodiment, each attempt by the devices to set up secure communication between these devices uses new public/private key pairs.

At blocks 204a and 204b each device's protocol module computes a SHA-256 (Secure Hash Algorithm 256) of the device's created public key: device A computes a hash of Pa to provide HPa and device B computes a hash of Pb to provide HPb.

At blocks 206a and 206b each device's wireless transmitter/receiver 110a or 110b publishes (e.g., transmits wirelessly) its respective hashes HPa or HPb. These hashes are assumed to be receivable by the other device, though an active interloper could intercept each. The active interloper, however, would have to provide the devices with its own hash to interlope between them but does not yet have the public keys on which the devices' hashes were made because each public key has not yet been transmitted.

At blocks 208a and 208b each device's wireless transmitter/receiver receives the other device's published hashes: device A receives HPb and device B receives HPa. Once each has received the other device's hash, they may then wirelessly transmit the public keys. The devices may also check to make sure that the hash received is not equal to the hash that was sent. If they are the hash received may have been reflected from a malicious interloper and so the devices abort.

At blocks 210a and 210b each device's wireless transmitter/receiver publishes (e.g., transmits wirelessly) its public keys: device A wirelessly transmits Pa and device B wirelessly transmits Pb.

At blocks 212a and 212b each device's wireless transmitter/receiver receives the other device's published public keys: device A receives Pb and device B receives Pa.

At blocks 214a and 214b each device's protocol module computes a SHA-256 hash of the public key received to check that the hash received matches the public key received. Thus, device A computes a SHA-256 hash of Pb and compares it with the hash HPb previously received. If they match, the process continues. If they do not, the process aborts. Device B does the same with Pa and HPa.

At blocks 216a and 216b each device's protocol module computes a session key Sk of its own private key and the received public key. Thus, device B computes a session key Sk(b) of Pa and Sb. Likewise, device A computes a session key Sk(a) of Pb and Sa. In this embodiment, each device does so using Elliptic Curve Diffie-Helman as will be understood by the skilled artisan.

At blocks 218a and 218b each device's protocol module computes a four-digit hash of its session key, its public key, and the other device's public key. Here device A computes a four-digit hash (e.g., “2048”) of Sk(a), Pa, and Pb and device B computes a four-digit hash (e.g., “2048”) of Sk(b), Pb, and Pa. Four digits are generally easy for a user to compare with a low probability of error and irritation to the user. If each device's session key is the same, the four-digit hash will also be the same. The session keys will be the same if the public key received from the other device is authentic. The authenticity of the public key received is proven to a very high probability by computing the SHA-256 hash of the received public key and comparing it with the previously received hash of that public key. At this point, however, the devices do not yet know if their four-digit hashes 4Ha and 4Hb are equivalent.

At blocks 220a and 220b each device's output-to-user element 112a or 112b displays its four-digit hash to a user. Thus, device A will display “2048” and device B will display “2048”. If the session keys of the devices were different, the odds of them both showing the same four-digit hash would be very low.

The user may look at both of the displays and determine if the displayed numbers match. If they do the user may indicate this. If they don't the user can abort the process and start over. Here the displayed numbers are the same, so the user indicates this through the input-from-user element 114a or 114b (e.g., presses an enter key on a laptop's keyboard and some button on a PDA). Note that the user's input is received out-of-band; his or her input is independent of the device's wireless communication with each other and so may not be intercepted by a malicious device or software. The devices do not need to have a shared secret before the protocol or share a secret with each other wirelessly during the protocol.

At blocks 222a and 222b each device receives through its input-from-user element the user's indication that the four-digit hashes match. If the user does not indicate this the process aborts before reaching blocks 224a or 224b.

At blocks 224a and 224b both devices communicate securely with each other.

### Other Embodiments of the Tools

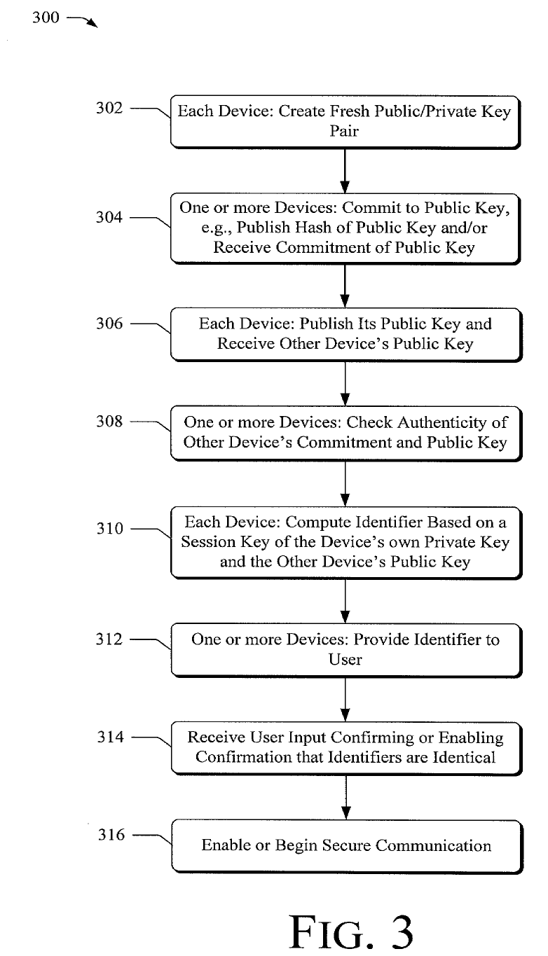

In the above section one exemplary way is described in which the tools may act to enable secure communication between commonly controlled devices. Other embodiments of the tools are provided below as part of a process 300 shown in FIG. 3. These embodiments of the tools are not intended to limit the scope of the tools or the claims.

Process 300 is illustrated as a series of blocks representing individual operations or acts performed by the tools. Process 300 may be performed by devices attempting to set up secure communications with help from one or more users. These devices may include devices 102a and 102b of FIG. 1 or other devices.

At block 302 each device creates a fresh public/private key pair. A fresh public key enables the tools to trust a received public key based on a previously received hash of that public key. It is possible for the devices to use public/private key pairs that are not just created, but those keys may not have been previously exposed to possible interlopers.

At block 304 at least one of the devices commits to its fresh public key, which is received by the other device. The tools may commit to a fresh public key by publishing a cryptographic hash of that public key so long as the cryptographic hash is not reversible. This publication may be wireless or otherwise, such as communication through a telephone or broad-band wired connection to the Internet. In the above example of FIG. 2, for instance, both devices A and B of FIG. 1 wirelessly publish a non-reversible SHA-256 hash of their public keys. Other hashes, such as SHA-0 or SHA-1, may also be used. In some embodiments, however, only one of the devices commits to its public key. The other device may just publish the public key, as noted below.

At block 306 each device publishes its public key and receives another device's public key. At least one of these public keys was committed to at block 304. This public key may be committed to because a hash of it was sent and will later be used to authenticate this public key. The probability of an interloper finding a fake public key having this same hash is extremely low based on the security of the cryptographic hash (e.g., SHA-256). And, even if the interloper could find such a fake public key, a session key of the fake public key would not match-also to a high probability.

At block 308 at least one of the devices authenticates the other device's public key based on the other device's commitment. The commitment, such as the above example of a SHA-256 hash of the public key, may be used to check that the public key is authentic. The tools may compute a same cryptographic hash of the public key as was received, such as computing a SHA-256 of the received public key and making sure that it matches the previously received cryptographic hash.

At block 310 each device computes an identifier. The identifier will be identical if the public keys received by each device are authentic. The identifier may be a hash of the session key alone or with other information to generate a number or text that may easily be handled by a user, such as three-to-seven alpha and/or numeric digits. More than seven digits are often difficult for users to accurately compare. Fewer than three digits (e.g., two) provide a potential interloper at least a 1% chance of success. The identifier need not be a particular type of hash or session key so long as it will, with a high probability, be identical only if the pubic keys received by each device are authentic. In the above example illustrated in FIG. 2 for instance, a four-digit number is used that is calculated by hashing an Elliptic Curve Diffie-Helman session key and the public keys.

At block 312 at least one of the devices provides the identifier in a form that is intelligible to a user. The user can confirm or disallow that the identifiers are the same for both devices. The user can also enable one or more of the devices to determine if the identifiers are identical. For example, one device may display its identifier and the other wait for the user to enter the identifier displayed. If the entered identifier is the same as the identifier calculated by the device in which it was entered, the device may determine that the identifiers are the same. In the above example of FIG. 2 both device A and device B display their identifiers (hashes of their session keys and both public keys) and await the user's confirmation that they are the same with a simple assent like pressing a button on each device.

At block 314 the devices receive a user's input confirming or enabling confirmation (or a disallow) that the identifiers are the same.

If the identifiers are the same, the devices at block 316 may commence communication with a very high probability that their communication is secure. Note that this probability is not subject to a cryptographic attack based on the size of the identifier presented to the user. If the identifier is a four-digit number the probability that an interloper has intercepted and breached the security protocol is related to the size of this number but the interloper is not able to create collisions or make some other cryptographic attack based on the size of this four-digit number. Rather, an interloper's cryptographic attack will have to successfully break the cryptographic hash of the public key or keys—which with SHA-256 or other currently used hashes is believed to be nearly impossible.

### CONCLUSION

The above-described tools enable secure communication between commonly controlled devices. The tools may do so without requiring a shared secret or complex user interaction with the devices. By so doing, users may more easily and/or securely use commonly controlled devices. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. One or more computer-readable media having computer-readable instructions therein that, when executed by a computing device, cause the computing device to implement a protocol comprising:
receiving a commitment of a public key from another computing device;
publishing another public key and receiving the first-mentioned public key from the other computing device;
authenticating the first-mentioned public key using the commitment; and
computing an identifier using the first-mentioned public key and a private key associated with the other public key.

2. The media of claim 1, wherein the protocol does not require a shared secret with the other computing device to enable cryptographically secure communication between the first-mentioned computing device and the other computing device.

3. The media of claim 1, further comprising presenting the identifier to a user and, responsive to receiving an indication from the user that the identifier is equal to a second identifier computed using the other public key and a second private key associated with the first-mentioned public key, enabling cryptographically secure communication with the other computing device.

4. The media of claim 1, wherein the identifier comprises a three-to-seven-digit alpha and/or numeric string computed using a cryptographic hash of a session key of the first-mentioned public key and the private key associated with the other public key.

5. The media of claim 1, further comprising committing to the other public key before publishing it by computing a cryptographic hash of the other public key and wirelessly transmitting that cryptographic hash.

6. The media of claim 1, wherein the first-mentioned computing device on which the instructions are executed is a first wireless computing device and the other computing device is a second wireless computing device.

7. A method implemented at least in part by a wireless computing device comprising:
committing to a first public key of a first public/private key pair before the first public key is published to provide a first commitment;
receiving a second commitment committing another wireless device to a second public key of a second public/private key pair before the second public key is published;
after and responsive to receiving the second commitment, publishing the first private key;
receiving the second public key from the other wireless device;
responsive to receiving the second public key, authenticating the second public key based on the second commitment committing the wireless device to the second public key;
computing a first session key of the first private key and the second public key;
providing to a user a first identifier based on the first session key; and
receiving an indication from the user that the first identifier is identical to a second identifier provided to the user by the other wireless device and based on a second session key of the second private key and the first public key, the first public key authenticated using the first commitment.

8. The method of claim 7, wherein the act of committing to the first public key computes a cryptographic hash of the first public key and publishes the cryptographic hash.

9. The method of claim 7, wherein the act of receiving the second commitment receives a publicly transmitted cryptographic hash of the second public key.

10. The method of claim 9, wherein the act of authenticating the second public key computes another cryptographic hash using the same cryptographic protocol over the second public key and authenticating the second public key if the other cryptographic hash matches the publicly transmitted cryptographic hash of the second public key.

11. The method of claim 7, wherein the act of computing the first session key performs a Diffie-Helman or Elliptic Curve Diffie-Helman of the first private key and the second public key.

12. The method of claim 7, further comprising computing the first identifier by performing a cryptographic hash over at least the first session key.

13. The method of claim 12, wherein the cryptographic hash is performed over a combination of the first session key, the first public key, and the second public key.

14. The method of claim 12, wherein the identifier is a four-digit number based on the cryptographic hash.

15. The method of claim 7, wherein the act of providing displays the first identifier to the user.

16. The method of claim 7, further comprising generating the first public/private key pair.

17. A first wireless computing device having one or more computer-readable media having computer-readable instructions therein that, when executed by the first wireless computing device, cause the first wireless computing device to perform acts capable of enabling communication with a second wireless computing device secure from an active interloper, the instructions comprising:
creating a first public/private key pair;
cryptographically hashing the first public key to provide a first cryptographic hash of the first public key;
wirelessly transmitting the first cryptographic hash;
wirelessly transmitting the first public key after receiving a second cryptographic hash of a second public key not identical to the first public key and part of a second public/private key pair;
authenticating the second public key by cryptographically hashing the second public key and confirming that this cryptographic hash is equal to the second cryptographic hash;
computing a session key of the second public key and the first private key;
hashing the session key to provide a first three-to-seven-digit identifier;
displaying the first identifier to a user; and
receiving confirmation from the user indicating that the first identifier is equivalent to a second identifier of the second wireless computing device.

18. The first wireless computing device of claim 17, wherein the act of cryptographically hashing the first public key uses SHA-0, SHA-1, or SHA-256.

19. The first wireless computing device claim 17, wherein the act of computing the session key uses Diffie-Helman or Elliptic Curve Diffie-Helman.

20. The first wireless computing device of claim 17, wherein the first identifier is a four-digit number.
